(19) United States
(12) Patent Application Publication
(10) Pub. No.: US 2013/0307246 A1
(43) Pub. Date: Nov. 21, 2013

(54) STORAGE UNIT FOR A BICYCLE

(71) Applicants: Robb H. Jankura, Los Gatos, CA (US); Jeffrey D. Juarez, Santa Cruz, CA (US)

(72) Inventors: Robb H. Jankura, Los Gatos, CA (US); Jeffrey D. Juarez, Santa Cruz, CA (US)

(73) Assignee: SPECIALIZED BICYCLE COMPONENTS, INC., Morgan Hill, CA (US)

(21) Appl. No.: 13/472,906

(22) Filed: May 16, 2012

(51) Int. Cl. B62K 3/02; B62J 9/02; B62J 11/00

(52) U.S. Cl. 280/281.1; 224/414; 224/425

(57) ABSTRACT

A bicycle including two wheels and a frame supported by the two wheels. The bicycle also includes a bottle cage coupled to the frame, and a storage unit including a first securing portion engaging a support portion of the bottle cage and a second securing portion secured to the frame.

### BACKGROUND

The present invention relates generally to bicycles, and more specifically to storage units that can be mounted on bicycles for storing items.

When riding a bicycle, it is often desired to carry certain items, such as tools, money, keys, a spare inner tube, a tube patch kit, compressed CO2, and food. These items can be carried in a variety of locations, such as the rider's pockets or a cycling pack. Cycling packs are commonly made of soft-sided material, such as heavy-duty woven nylon, and can be attached to the bicycle are a number of different locations, such as the seat, the handlebars, or the frame tubes. These cycling packs are commonly secured to the bicycle using nylon straps with hook-and-loop fasteners.

### SUMMARY

The present invention provides a bicycle including two wheels and a frame supported by the two wheels. The bicycle also includes a bottle cage coupled to the frame, and a storage unit including a first securing portion engaging a support portion of the bottle cage and a second securing portion secured to the frame.

The present invention also provides a bicycle storage assembly including a bottle cage and a storage unit that has a first securing portion adapted to engage a support portion of the bottle cage and a second securing portion adapted to be secured to a bicycle frame.

The present invention further provides a bicycle storage unit including a first securing portion adapted to engage a support portion of a bottle cage, and a second securing portion adapted to be secured to a bicycle frame.

Other aspects of the invention will become apparent by consideration of the detailed description and accompanying drawings.

### BRIEF DESCRIPTION OF THE DRAWINGS

FIG. 1 is a side view of a bicycle including a storage unit and bottle cage embodying the present invention.

FIG. 2 is an enlarged perspective view of the storage unit, bottle cage, and a portion of the bicycle of FIG. 1.

FIG. 3 is an exploded perspective view of the storage unit, bottle cage, and the portion of the bicycle of FIG. 2.

FIG. 4 is a section view taken along line 4-4 in FIG. 2.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

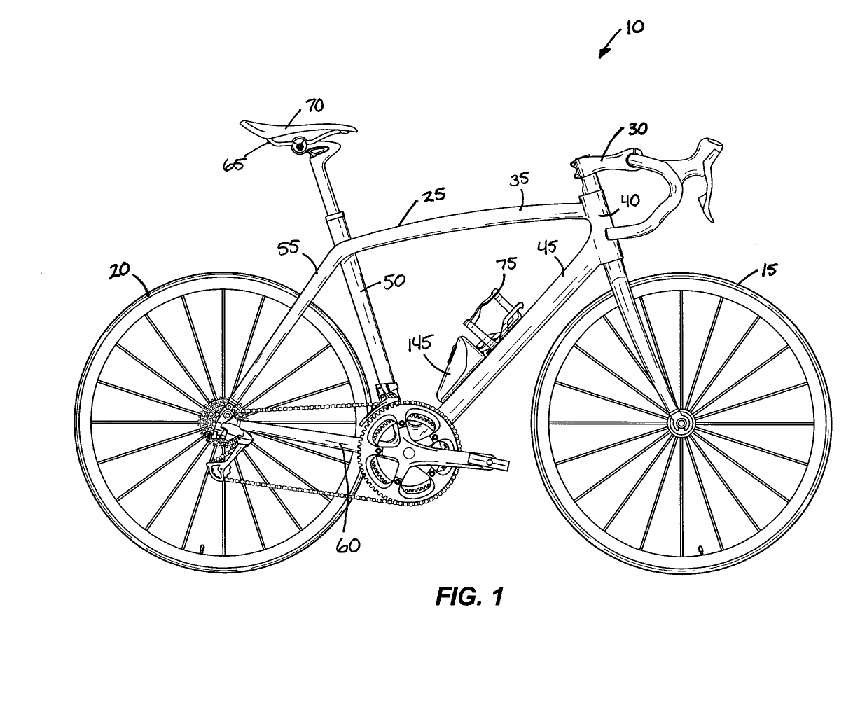

FIG. 1 illustrates a bicycle 10 that includes a front wheel 15, a rear wheel 20, a frame 25, and a steering assembly 30. The frame 25 includes a top tube 35, a head tube 40, a down tube 45, a seat tube 50, seatstays 55, and chainstays 60. A bicycle seat assembly 65 is supported by the frame 25 and includes a seat 70 upon which a rider sits while riding the bicycle 10.

FIGS. 1-4 show that the bicycle 10 also includes a bottle cage 75 that is coupled to the down tube 45, although the bottle cage 75 can be attached to other portions of the frame 25 (e.g., the top tube 35, the seat tube 50), if desired. As illustrated, the down tube 45 has a first threaded opening 80 and a second threaded opening 85 spaced apart from each other by a distance D1 (e.g., approximately 64 millimeters). The bottle cage 75 supports a bottle (not shown) and is defined by a shell 90 that surrounds the bottle. The shell 90 has a support portion 95 positioned to abut a lower end of the bottle, a first fastener tab 100 connected to the support portion 95, and a second fastener tab 105 formed as part of the shell 90. Each fastener tab 100, 105 has a hole 110 through which fasteners 115 are inserted into the first and second openings 80, 85 to attach the bottle cage 75 to the down tube 45. The illustrated fastener tabs 100, 105 are axially aligned with each other and are elongated in the longitudinal direction of the down tube 45 to permit some adjustment of the bottle cage 75 along the down tube 45 and to accommodate a variation of the spacing of the openings 80, 85.

The support portion 95 is defined by a wall 120 that has a top edge 125 and a bottom edge 130 and an aperture 135 extending through the wall 120 between the top edge 125 and the bottom edge 130. The interior side of the support portion 95 (i.e., where the bottle is supported) has a generally concave or inwardly-shaped curvature conforming to the shape of a bottom portion of a typical bottle such that the bottom edge 130 defines inwardly rounded corners 140 at both ends of the wall 120. The illustrated aperture 135 is trapezoidal-shaped, although the aperture 135 can have other shapes (e.g., triangular, rectangular, polygonal, circular, elliptical, etc.).

With reference to FIGS. 1-4, a storage unit 145 is attached to the bicycle 10 adjacent the bottle cage 75. The storage unit 145 defines a housing that has a storage area 150 for storing supplies and tools. The illustrated storage unit 145 has a substantially aerodynamic profile that tapers smaller moving away from the head tube 40, although the storage unit 145 can have other profiles. The storage unit 145 also has a door 155 that is movable between an open position and a closed position (e.g., via a hinge 160) to provide access to the storage area 150 so that supplies and tools can be secured and retrieved as desired. The illustrated storage unit 145 also has a toggle latch 165 that secures the door 155 in the closed position. In some constructions, the door 155 and the latch 165 can accommodate a lock to secure the items disposed in the storage unit 145. As illustrated, the door 155 is positioned on the side of the storage unit 145 to provide a relatively large access opening to the storage area 150, although the door can be provided on other walls of the storage unit 145.

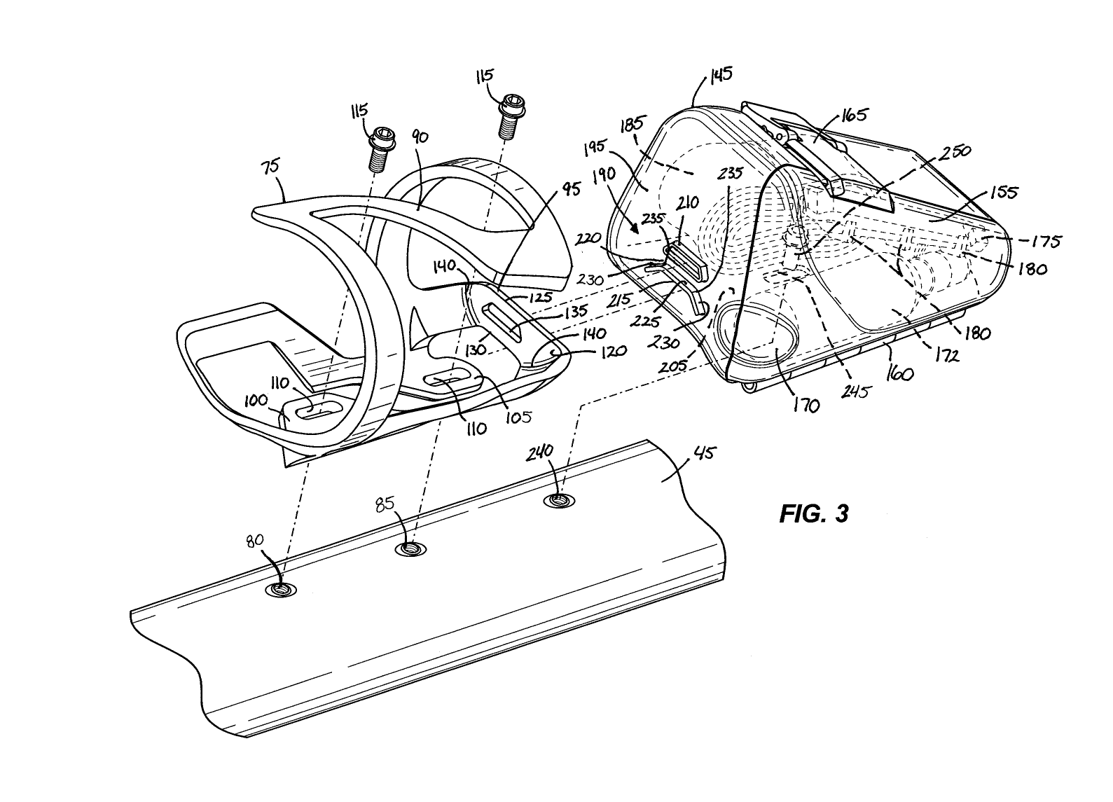

As shown in FIG. 3, the storage unit 145 has a recess 170 into which a CO2 cartridge 172 is secured. The illustrated housing also supports other supplies and tools, including a tire lever 175 that is secured to an inward side of the door 155 using snap members 180, and an inner tube 185 that is placed in the hollow body. The storage unit 145 also can support other tools, such as a multi-tool and a patch kit.

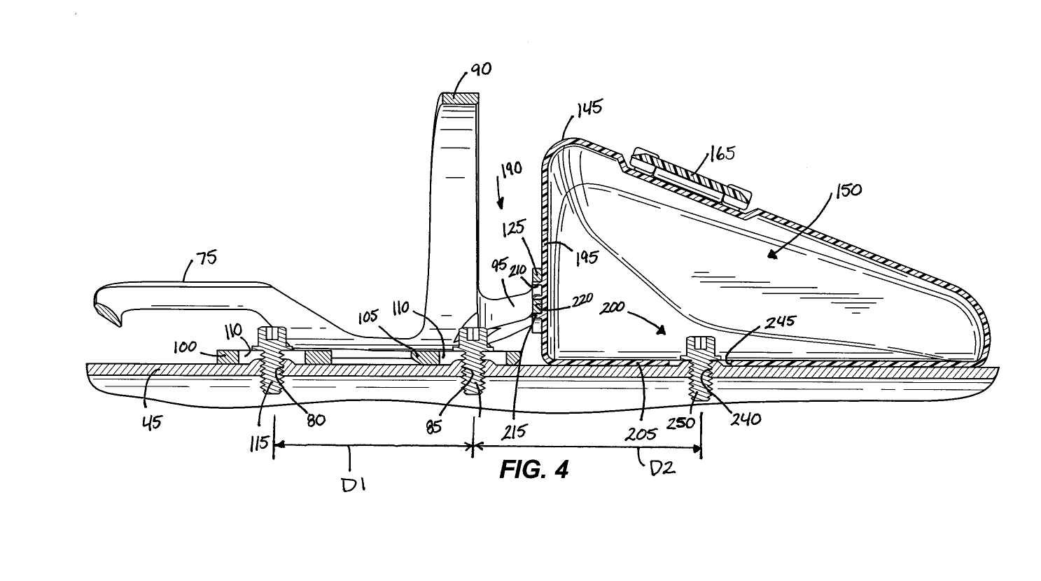

As shown in FIGS. 3 and 4, the storage unit 145 also includes a first securing portion 190 on a forwardly located wall 195 of the housing and a second securing portion 200 on a lower wall of the housing 205. The first securing portion 190 is engageable with or securable to the bottle cage 75 within the support portion 95 adjacent a backside of the cage 75.

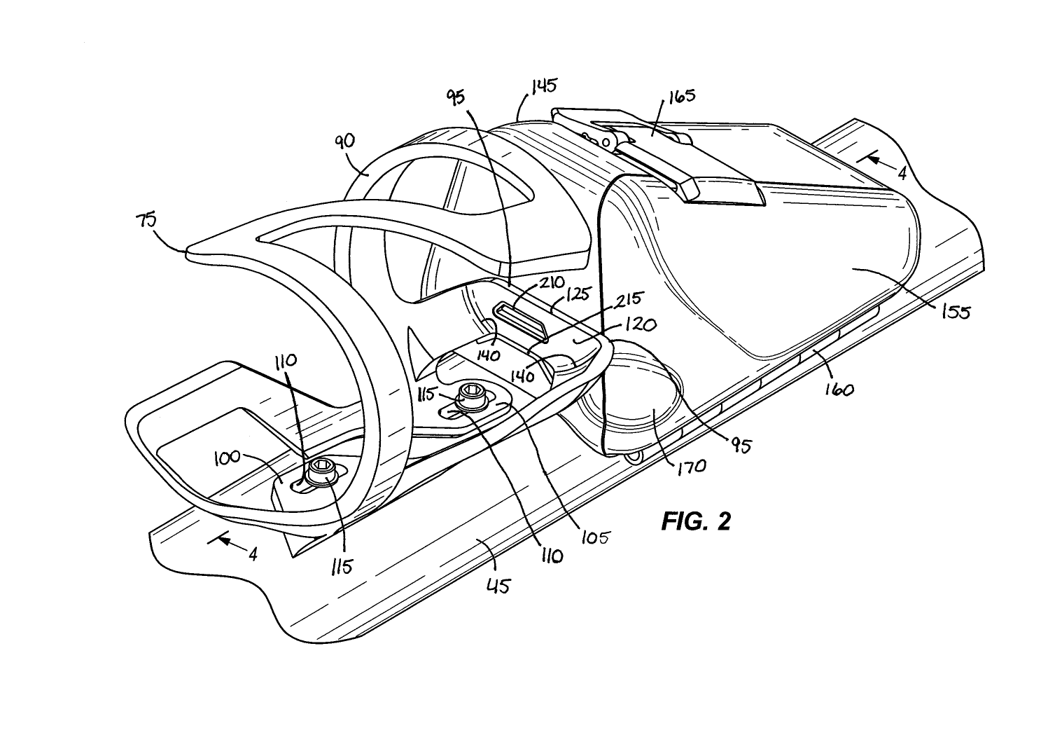

The illustrated first securing portion 190 is defined by a protrusion 210 extending outward from the forwardly located wall 195, a clip 215 spaced apart from the protrusion 210, and a recess 220 between the protrusion 210 and the clip 215. As shown in FIGS. 2 and 3, the protrusion 210 is shaped to match the aperture 135 in the support portion 95 and serves to align the storage unit 145 with the bottle cage 75 when the storage unit 145 is attached to the bicycle 10.

The clip 215 extends outward from the forwardly located wall 195 and is engageable with the lower edge of the support portion 95. As illustrated, the clip 215 has a central portion 225 extending outward from the wall 195, and opposed edge portions 230 extending outward from the wall 195 and angled downward relative to the central portion 225 such that clip 215 has outwardly rounded corners 235 at the juncture between the central portion 225 and the edge portions 230. In some constructions, the clip 215 can also angle upward from the wall 195. The central portion 225 is slidably engageable with the lower edge of the support portion 95, and the outwardly rounded corners 235 are slidably engageable with the inwardly rounded corners 140 of the support portion 95 to secure the storage unit 145 to the bottle cage 75. In other words, the clip 215 is shaped to substantially conform to the shape of the lower edge of the support portion 95. Also, the recess 220 between the protrusion 210 and the clip 215 receives a lower portion of the wall 120 of the support portion 95 between the aperture 135 and the bottom edge 130 so that the wall 120 of the housing is in close proximity to the support portion 95 after the storage unit is attached to the cage 75. In other constructions, other male-female connector combinations can be used to engage the storage unit to the backside of the bottle cage 75.

The second securing portion 200 is engageable with or securable to the frame 25 (e.g., the down tube 45). As illustrated in FIGS. 3 and 4, the down tube 45 has a third threaded opening 240 that is spaced apart from the second threaded opening 85 by a distance D2 (e.g., approximately 64 millimeters) that is substantially equal to the distance D1. The second securing portion 200 has a hole 245 through which a fastener 250 is inserted into the third opening 240 to attach the storage unit to the down tube 45. The illustrated hole 245 is substantially axially aligned with the first and second holes 110 of the cage 90, and the hole can be elongated to permit slight movement of the storage unit along the down tube 45 and to accommodate a variation of the spacing of the openings 85, 240. As illustrated, the distance D2 is substantially equal to the distance D1 so that when the storage unit is removed from the bicycle 10, the cage 90 can be attached to the down tube 45 via the first and second openings 80, 85, or via the second and third openings 85, 240.

The storage unit can be attached to and detached from the bicycle 10 as desired via the first securing portion 190 and the second securing portion 200. The first and second securing portions 190, 200 provide for relatively quick attachment and detachment while firmly securing the storage unit in a location that does not obstruct the rider. As discussed above, the bottle cage 75 can be repositioned as desired using the first, second, and third openings 80, 85, 240 when the storage unit is removed or otherwise not positioned on the bicycle 10.

The cage 75 and the storage unit 145 can be attached to the down tube 45 together or separately, although in most situations, the cage 75 is likely attached to the down tube 45 before the storage unit 45. To attach the cage 75 to the down tube 45, the holes 110 of the fastener tabs 100, 105 are aligned with the first and second openings 80, 85 in the down tube 45. The fasteners 115 are then inserted through the holes 110 into the openings 80, 85 to secure the cage 75 to the down tube 45. The storage unit 45 is placed so that the first securing portion 190 is aligned with the support portion 95, and then the storage unit 45 is moved toward the cage 75 so that the protrusion 210 engages the wall 120 within the aperture 135 and the clip 215 engages the bottom edge 130.

The second securing portion 200 is aligned and engaged with the down tube 45 so that the storage unit 145 is supported on the down tube 45. More specifically, the fastener 250 is then inserted through the hole 245 into the opening 240, securing the storage unit 145 to the down tube 45. When the storage unit 145 is attached to the down tube 45 and to the cage 75, the first and second securing portions 190, 200 cooperate with each other to resist longitudinal and lateral movement of the storage unit 145 relative to the down tube 45. The door 155 can be opened and closed by operating the latch 165 to provide access to the storage area 150 for storage or retrieval of tools or other items.

Various features and advantages of the invention are set forth in the following claims.

1. A bicycle comprising:
two wheels;
a frame supported by the two wheels;
a bottle cage coupled to the frame;
a storage unit including a first securing portion engaging a support portion of the bottle cage and a second securing portion secured to the frame.

2. A bicycle as claimed in claim 1, wherein the frame includes first and second threaded openings, and wherein the bicycle further includes:
first and second fasteners securing the bottle cage to the frame using the first and second threaded openings.

3. A bicycle as claimed in claim 2, wherein the frame includes a third threaded opening and wherein the bicycle further includes a third fastener securing the second securing portion of the storage unit to the third threaded opening.

4. A bicycle as claimed in claim 3, wherein the first and second threaded openings are spaced by a first distance and the second and third threaded openings are space by a second distance substantially equal to the first distance.

5. A bicycle as claimed in claim 1, wherein the first securing portion of the storage unit includes a recess shaped to substantially match a shape of the support portion of the bottle cage.

6. A bicycle as claimed in claim 1, wherein the storage unit includes a hollow body and a door movable between open and closed positions.

7. A bicycle as claimed in claim 6, wherein the hollow body includes a recess, and wherein the bicycle further includes a CO2 cartridge secured in the recess.

8. A bicycle as claimed in claim 6, wherein the bicycle further includes a tire lever secured to the door.

9. A bicycle as claimed in claim 6, wherein the bicycle further includes an inner tube positioned in the hollow body.

10. A bicycle storage assembly comprising:
a bottle cage;
a storage unit including a first securing portion adapted to engage a support portion of the bottle cage and a second securing portion adapted to be secured to a bicycle frame.

11. A bicycle storage assembly as claimed in claim 10, wherein the first securing portion of the storage unit includes a recess shaped to substantially match a shape of the support portion of the bottle cage.

12. A bicycle storage assembly as claimed in claim 10, wherein the storage unit includes a hollow body and a door movable between open and closed positions.

13. A bicycle storage assembly as claimed in claim 12, wherein the hollow body includes a recess, and wherein the assembly further includes a CO2 cartridge secured in the recess.

14. A bicycle storage assembly as claimed in claim 12, wherein the assembly further includes a tire lever secured to the door.

15. A bicycle storage assembly as claimed in claim 12, wherein the assembly further includes an inner tube positioned in the hollow body.

16. A bicycle storage unit comprising:
a first securing portion adapted to engage a support portion of a bottle cage; and
a second securing portion adapted to be secured to a bicycle frame.

17. A bicycle storage unit as claimed in claim 16, wherein the first securing portion of the storage unit includes a recess shaped to substantially match a shape of the support portion of the bottle cage.

18. A bicycle storage unit as claimed in claim 16, wherein the storage unit includes a hollow body and a door movable between open and closed positions.

19. A bicycle storage unit as claimed in claim 18, wherein the hollow body includes a recess, and wherein the unit further comprises a CO2 cartridge secured in the recess.

20. A bicycle storage unit as claimed in claim 18, further comprising a tire lever secured to the door.

21. A bicycle storage unit as claimed in claim 18, further comprising an inner tube positioned in the hollow body.
